(19) United States
(12) Patent Application Publication
(10) Pub. No.: US 2020/0170474 A1
(43) Pub. Date: Jun. 4, 2020

(54) ROBOT AND ROBOT SYSTEM

(71) Applicant: SHENZHEN LDROBOT CO., LTD., Shenzhen (CN)

(72) Inventor: You WU, Shenzhen (CN)

(21) Appl. No.: 16/615,126

(22) PCT Filed: Apr. 28, 2018
(86) PCT No.: PCT/CN2018/085088

§ 371 Date: Nov. 19, 2019

(30) Foreign Application Priority Data
Jun. 14, 2017 (CN) 201710449851.8

(51) Int. Cl. A47L 11/40; B25J 9/16; B25J 11/00; G06K 9/62; A47L 11/24

(52) U.S. Cl. CPC A47L 11/4011; B25J 9/163; A47L 11/24; B25J 11/0085; G06K 9/624; B25J 9/1679

(57) ABSTRACT

A robot (10), including: an acquisition module (100) configured to acquire a map of an environment where the robot is located; a dividing module (200) configured to divide the map into a plurality of target regions according to feature information recorded in the map; and a marking module (300) configured to mark a corresponding attribute and a task category corresponding to the attribute for each target region, so that the robot performs a corresponding action according to the corresponding attribute and the task category after entering any target regions. A robot system including the aforesaid robot (10) is further provided.

### CROSS-REFERENCE TO RELATED APPLICATION

The present disclosure claims priority to Chinese patent application No. 201710449851.8, filed with CNIPA on Jun. 14, 2017 and entitled “robot and robot system”, the content of which is incorporated herein by reference in its entirety.

### TECHNICAL FIELD

The present disclosure relates to the technical field of intelligent control, and more particularly to a robot and a robot system.

### BACKGROUND

In the technology of robots, a household robot plays an important role, a typical example of the household robot includes a cleaning robot, and the most basic and important function of the cleaning robot is accurately recognize its position so as to perform a corresponding action. Where, in the path planning of the robot, each time when the robot is applied to a new environment or an old map is changed, the robot needs to explore the surrounding environment and establish or update the map. When the robot performs a task, manual intervention and manipulation are always needed, and the tasks which may be automatically performed are unitary, the robot may complete tasks intelligently and orderly according to regions after a map dividing algorithm is provided.

For example, a cleaning robot in the market usually performs an overall cleaning or only performs a local cleaning near the position where the cleaning robot is located; however, the cleaning robot may not follow a designated command of the user such as a living room cleaning command;
for another example, a security protection and patrol robot may not complete a designated command of the user, such as a command of watching the grandma's bedroom; in other words, the robots in the prior art may not effectively meet a use requirement of the user, the user experience is reduced, so that the robots in the prior art need to be improved.

### SUMMARY

The present disclosure is for the purpose of at least solving one of the technical problems in the related art to some extent.

For this purpose, an objective of the present disclosure is providing a robot, this robot may improve the accuracy of map dividing, improve the intelligence, the applicability and the reliability of the robot, optimize user operation, and make the user operation to be simple and convenient, so that user experience is improved.

Another objective of the present disclosure is providing a robot system.

For achieving the objectives mentioned above, in one aspect, one embodiment of the present disclosure provides a robot, including: an acquisition module configured to acquire a map of an environment where the robot is located; a dividing module configured to divide the map into a plurality of target regions according to feature information recorded in the map; and a marking module configured to mark a corresponding attribute and a task category corresponding to the attribute for each target region, so that the robot performs a corresponding action according to the corresponding attribute and the task category after entering any target region.

In the robot of the embodiment of the present disclosure, a map is divided into a plurality of target regions according to feature information, so that a corresponding attribute and the task category corresponding to the attribute are marked for each target region, and an intelligent control of the robot is implemented, not only the accuracy of map dividing is improved, but also the applicability and the reliability of robot is improved, the user operation is optimized and become more simple and convenient, and the user experience is improved.

Additionally, the robot in the aforesaid embodiment of the present disclosure may also have additional features as follow:

Furthermore, in one embodiment of the present disclosure, the robot further includes a generation module configured to generate a region tag according to the corresponding attribute and/or the task category corresponding to the attribute which is/are marked for each target region; and a conversion module configured to convert the region tag into a control command of a remote control device that matches with the robot.

Furthermore, in one embodiment of the present disclosure, the dividing module is particularly configured to draw the plurality of target regions on the map.

Furthermore, in one embodiment of the present disclosure, the dividing module is particularly configured to classify the map according to terrain features of the map and divide the plurality of target regions according to a classification result.

Furthermore, in one embodiment of the present disclosure, the dividing module is particularly configured to divide the plurality of target regions according to historical tasks which are performed by the robot in different regions of the map.

Furthermore, in one embodiment of the present disclosure, the attribute includes a region name, a category and a mark, and the task category comprises a working mode, a working time and a working intensity.

Furthermore, in one embodiment of the present disclosure, the robot further includes a numbering module configured to number each target region in the plurality of target regions.

Furthermore, in one embodiment of the present disclosure, the robot further includes an establishment module configured to establish an association relationship between the attributes and the numbers of the plurality of target regions and multiple keys in the remote control device so as to send a corresponding control command to the robot after any one of the plurality of keys is triggered, so that the robots performs the corresponding action after entering the corresponding target region according to the corresponding attributes and the numbers.

For achieving the objectives mentioned above, in another aspect, the present disclosure provides a robot system, including remote control device and the robot as mentioned above. In this robot system, a map is divided into a plurality of target regions according to feature information, so that a corresponding attribute and the task category corresponding to the attribute are marked for each target region, and an intelligent control of the robot is implemented, not only the accuracy of map dividing is improved, but also the applicability and the reliability of robot is improved, the user operation is optimized and become more simple and convenient, and the user experience is improved.

Optionally, in one embodiment of the present disclosure, the remote control device is a remote control.

Additional aspects and advantages of the present disclosures will be provided in the following descriptions, and some aspects and advantages will become obvious from the following descriptions or be understood according to the practice of the present disclosure.

### BRIEF DESCRIPTION OF THE DRAWINGS

In order to explain the embodiments of the present disclosure more clearly, a brief introduction regarding the accompanying drawings that need to be used in the embodiments is given below; it is obvious that the accompanying drawings described as follows are only some embodiments of the present disclosure, for the person of ordinary skill in the art, other drawings can also be obtained according to the current drawings on the premise of paying no creative labor.

FIG.1 depicts a schematic structural diagram of a robot according to one embodiment of the present disclosure; and

FIG. 2 depicts a diagrammatic illustration of a principle of map dividing and remote control device according to one embodiment of the present disclosure.

### DESCRIPTION OF THE EMBODIMENTS

Herein, embodiments of the present disclosure are described in detail, and examples of the embodiment are illustrated in the accompanying figures; wherein, an always unchanged reference number or similar reference numbers represent(s) identical or similar components or components having identical or similar functionalities. The embodiment described below with reference to the accompanying figures is illustrative and intended to illustrate the present disclosure, but should not be considered as any limitation to the present disclosure.

A method of dividing regions of a map, a robot and a robot system proposed in the embodiments of the present disclosure are described with reference to the accompanying figures, firstly, the method of dividing regions of a map proposed in the embodiments of the present disclosure is described with reference to the accompanying figures.

FIG. 1 depicts a schematic structural diagram of a robot according to one embodiment of the present disclosure.

As shown in FIG. 1, the robot 10 includes an acquisition module 100, a dividing module 200 and a marking module 300.

Where, the acquisition module 100 is configured to acquire a map of an environment where the robot is located. The dividing module 200 is configured to divide the map into a plurality of target regions according to the feature information recorded in the map. The marking module 300 is configured to mark a corresponding attribute and a task category corresponding to the attribute for each task region, so that the robot performs a corresponding action according to the corresponding attribute and the task category after entering any target region. The robot 10 in this embodiment of the present disclosure may divide a map into a plurality of target regions, so that the corresponding attribute and the task category corresponding to the attribute are marked, and a accuracy of map dividing is improved, an applicability and a reliability of the robot are improved, a user operation is optimized and become more simplified and more convenient, and a user experience is improved.

It should be understood that there are many map acquisition methods, for example, a map of the environment where a cleaning robot or other kinds of mobile robots are located may be built through a modeling and a positioning algorithm, and there are various required signal sources, an input data source of the modeling and the positioning algorithm may be realized by equipping the mobile robot with one or a plurality of sensors such as a laser radar, a depth camera, an infrared distance measuring device, an ultrasonic wave, an IMU (Inertial Measurement Unit) and an odometer, and the like.

Position information of an environmental obstacle may be recorded on the map, and the robot may move in an obstruction-free region and in a region which haven't been explored by an unknown robot yet.

It should be understood that, after the map is acquired, regions may be divided by a software operation mode, or by an intelligent identification partitioning method through a machine learning algorithm, or by historical tasks, the method of dividing map is described in detail below, but is not limited by the following descriptions.

Where, in one embodiment of the present disclosure, the dividing module 200 is particularly configured to draw a plurality of target regions on the map.

Further, in one embodiment of the present disclosure, the dividing module 200 is particularly configured to classify the map according to terrain features of the map and divide the plurality of target regions according to a classification result.

Additionally, in one embodiment of the present disclosure, the dividing module 200 is configured to divide the map into a plurality of target regions according to the historical tasks which are performed by the robot in different regions of the map.

That is, the step of dividing the map into the plurality of target regions according to terrain feature information recorded in the map includes: drawing the plurality of target regions on the map; or classifying terrain features of each pixel block in the map using a trained classifier, and dividing the map into the plurality of target regions according to a classification result, for example, map databases are collected, each map database includes map data and attribute tag data, the feature and the corresponding attribute tag of each pixel block in the database are trained and learned using a machine learning method, a region attribute classifier is acquired, then, the region attribute classifier is used to classify the features of each pixel block in the map, and the classified result is processed through a preset algorithm, so that the map is divided into the plurality of target regions; or the map is divided into the plurality of target regions according to historical tasks which are performed by the robot in different regions of the map.

For example, a user may divide the regions drawn on the map through a software application. A map drawing mode may be applied to software applications such as an application in a mobile phone, a small application on Wechat public platform, a webpage application, a computer application and the like, and may include multiple operation modes such as drawing lines, connecting points to form lines, multipoint customization regions and the like. In addition, due to various reasons such as the precision of the map is limited, the operation modes of the user are limited and the like, there is an error between the operation data of the user and the actual expected operation, the regions drawn by the user may be optimized by applying corresponding method, for example, by analyzing a condition of an obstacle in the region drawn by the user and performing automatic contraction or expansion on deformed regions, such that the distribution condition of the obstacles in the regions drawn by the user are enabled to be consistent with the distribution condition of the obstacles on the map, a safety distance away from the obstacles may be set, the dividing operation of the user may be intelligently optimized, and it is not repeatedly described in detail herein.

For another example, the divided map may be intelligently recognized by the machine learning method, and an attribute of each region of the map may be marked. For example, huge map data is collected firstly, the regions of the map are divided, and the attribute of each region (e.g., a living room, a bedroom, a study, a balcony) is marked. The features of each pixel block are extracted, where the features have texture features and differential features with surrounding pixels, then, a classifier for recognizing the attribute of each pixel block is learned through the machine learning method, so that the possible attribute and the corresponding confidence level of each pixel block in the map are recognized. Since a common shape of each region in the map is square, and a complete square shape may not be seen on the map due to the obstacles, the possible rectangular regions may be divided through a rectangular approximation method in image, the regions and the attributes of the regions in the map may be estimated with combination of the calculated attributes and confidence levels of the pixel blocks as mentioned above.

For another example, the regions may be divided by tasks of a historical robot, for example, regarding a sweeper, the attributes of the regions may be automatically identified according to a task command of the historical robot; regarding a cleaning robot, a cleaning grade of each region may be intelligently recognized according to a distribution condition of the historical cleaning regions, the garbage distribution and the quantity of garbage recorded in the sweeping process, for example, the cleaning grade of the regions may be classified into a fine cleaning region and an ordinary cleaning region.

Optionally, in one embodiment of the present disclosure, the attribute includes a region name, a category, and a tag, the task category includes a working mode, a working time, and a working intensity.

In other words, after the regions are divided, the user may mark the attribute of each region such as the living room, the kitchen, the study, and the like, the attribute of each region may also be intelligently recognized according to the machine learning algorithm, except for the region name, the task category of the mobile robot in this region may also be marked, so that the robot may intelligently implement different task plans according to different attributes of the regions such as the information of sweeping mode, cleanliness and the like, when the robot enters the corresponding region to operate; meanwhile, the user may also customize effective time of a task in each region to implement performing different tasks in a certain region on time by the robot, and it is not limited in detail herein.

Furthermore, in one embodiment of the present disclosure, the robot 10 in this embodiment further includes a numbering module. Where, the numbering module is configured to number each target region in a plurality of target regions.

For example, as shown in FIG. 2, the divided regions are numbered to generate commands of an input device of the robot; for example, the robot may input a movement command through an input device (e.g., a terminal device such as a mobile phone, a remote controller, a tablet, and so on) that matches with the robot, the robot may be controlled to move to a region corresponding to the movement command to perform operation. Command transmission between the cleaning robot and the input device may be implemented in a wireless communication mode, and it is not limited in detail.

Furthermore, in one embodiment of the present disclosure, the robot 10 in this embodiment of the present disclosure further includes an establishment module.

The establishment module is configured to establish an association relationship between attributes and numbers of a plurality of target regions and multiple keys in the remote control device so as to send a corresponding control command to the robot after any one of the multiple keys is triggered, so that the robot may perform a corresponding action after entering the corresponding target region according to corresponding attribute and number.

Furthermore, in one embodiment of the present disclosure, the robot 10 further includes a generation module and a conversion module.

The generation module is configured to generate a region tag according to a corresponding attribute and/or a task category corresponding to the attribute which is/are marked for each target region. The conversion module is configured to convert the region tag into a control command of remote control device that matches with the robot.

In other words, a fixed command for controlling robot, which controls the robot to perform regional-related tasks through the general remote control device and is converted using region tags of the map, is generated by the region tag, so that the remote control device for controlling robot is manufactured.

As shown in FIG. 2, in case that a remote controller corresponding to the regional information is manufactured. Regarding the cleaning robot 101, a remote controller 102 may be manufactured, the buttons on the remote controller 102 may include a living room, a study, a bedroom, and an office, the user only needs to press the button of living room on the remote controller 102, so that the cleaning robot is informed that the region of the living room needs to be cleaned, and then intelligently recognize the region of the living room in the map to perform cleaning; the user may also customize the region corresponding to the keys of the remote controller. In the embodiment of the present disclosure, the user experience can be greatly improved by the remote controller, and user operation is facilitated.

Additionally, other components and functions of the robot are known to the person of ordinary skill in the art, and are not repeatedly described in order to reduce redundancy.

According to the robot in the embodiments of the present disclosure, the map is divided into a plurality of target regions through feature information, so that the corresponding attribute and the task category corresponding to the attribute are marked for each target region, and an intelligent control of the robot is realized; the regions of the map corresponding to the environment where the robot is located are intelligently divided, so that it is convenient for the user to set different tasks for different regions, the fixed command for controlling the robot may be generated according to the result of dividing of regions, so that the universal remote control device is manufactured, the robot may arrange different tasks according to different regions, and the universal remote controller may be manufactured to control the robot to move to the fixed position of the tag to perform task, not only a accuracy of map dividing is improved, but also the applicability and the reliability of the robot are improved; moreover, the remote controller or the application software corresponding to a home region name may be directly controlled, such that the operation of the user is intelligent and convenient, the experience of the user on the control of the mobile robot is improved, user operation is optimized to become more simplified and more convenient.

Additionally, the embodiment of the present disclosure further provides a robot system, this robot system includes the robot and the remote control device as mentioned above. In this robot system, the map may be divided into a plurality of target regions through feature information, the corresponding attribute and the task category corresponding to the attribute are marked for each target region, so that an intelligent control of the robot is realized; the regions of the map corresponding to the environment where the robot is located are intelligently divided, so that it is convenient for the user to set different tasks for different regions, not only the accuracy of map dividing is improved, but also the applicability and the reliability of the robot are improved; moreover, the remote controller or the application software corresponding to a home region name may be directly controlled, such that the operation of the user is intelligent and convenient, the experience of the user on the control of the mobile robot is improved, the robot system is simple and is prone to be implemented.

Optionally, in one embodiment of the present disclosure, the remote control device may be a remote control.

In the description of the present disclosure, it needs to be understood that, direction relationships or location relationships which are indicated by terms such as “center”, “longitudinal direction”, “horizontal direction”, “length”, “width”, “up”, “down”, “front”, “rear”, “left”, “right”, “vertical”, “horizontal”, “top”, “bottom”, “inside”, “outside”, “clockwise”, “anticlockwise”, “axial”, “radial”, “circumferential” and the like are the direction relationships or the location relationships shown in the accompanying figures, and are only intended to describe the present disclosure conveniently and simplify the description, rather than indicating or implying that an indicated device or component must have specific locations or be constructed and manipulated according to specific locations; therefore, these terms shouldn't be considered as any limitation to the present disclosure.

In addition, terms of “the first” and “the second” are only used for the description of purposes, and should not be considered as indicating or implying any relative importance, or impliedly indicating the number of indicated technical features. As such, technical feature(s) restricted by “the first” or “the second” can explicitly or impliedly comprise one or more such technical feature(s). In the description of the present disclosure, “a plurality of” has the meaning of two or more, such as two, three and so on, unless there is additional explicit and specific limitation.

In the present disclosure, unless there is additional explicit stipulation and limitation, terms such as “mount”, “connect with each other”, “connect”, “fix”, and so on should be broadly interpreted, for example, “connect” can be interpreted as being fixedly connected, detachably connected, or connected integrally; “connect” can also be interpreted as being mechanically connected or electrically connected; “connect” can be further interpreted as being directly connected or indirectly connected through intermediary, or being internal communication between two components or an interaction relationship between the two components, unless there is additional explicit stipulation and limitation. For the person of ordinary skill in the art, the specific meanings of the aforementioned terms in the present disclosure can be interpreted according to specific conditions.

In the present disclosure, unless there is explicit stipulation and limitation, the first feature is “above” or “under” the second feature can be interpreted as the first feature is in direct contact with the second feature or the first feature is in indirect contact with the second feature through an intermediate medium. Also, the first feature is “above”, or “at the top of” or “arranged on” the second feature can be interpreted as the first feature is above or obliquely above the second feature, or merely indicates that the first feature is higher than the second characteristic in height. The first feature is “below”, or “at the bottom of”, or “underneath” the second feature can be interpreted as the first feature is below or obliquely below the second feature, or merely indicates that the first feature is lower than the second feature in height.

In the description of the present disclosure, the descriptions of the reference terms such as “one embodiment”, “some embodiments”, “example”, “specific example” or “some examples” and the like means that the specific technical features, structures, materials or characteristics which are described with reference to the embodiments or the examples are included in at least one embodiment or example of the present disclosure. In the description of the present disclosure, a schematic expressions of the terms mentioned above don't necessarily aim at the same embodiment or example. Furthermore, the specific technical features, structures, materials, or characteristics described above may be combined in any suitable manner in any of one or a plurality of embodiments or examples. In addition, under the condition of without conflicting with each other, different embodiments or examples described in the description and the features in the different embodiments or examples may be integrated and combined by the person of ordinary skill in the art.

Although the embodiments of the present disclosure have been illustrated and described above, it should be understood that, the embodiments mentioned above are merely for illustrative, and shouldn't be interpreted as limitation to the present disclosure, the person of ordinary skill in the art may change, modify, replace the embodiments and make variations based on the embodiments.

1. A robot, comprising:
an acquisition module configured to acquire a map of an environment where the robot is located;
a dividing module configured to divide the map into a plurality of target regions according to feature information recorded in the map;
a marking module configured to mark a corresponding attribute and a task category corresponding to the attribute for each target region, so that the robot performs a corresponding action according to the corresponding attribute and the task category after entering any target region;
a generation module configured to generate a region tag according to the corresponding attribute and/or the task category corresponding to the attribute which is/are marked for each target region; and
a conversion module configured to convert the region tag into a control command of a remote control device that matches with the robot.

2. The robot according to claim 1, wherein the plurality of target regions are divided according to functionalities thereof.

3. The robot according to claim 1, wherein the dividing module is further configured to classify a terrain feature of each pixel block in the map using trained classifier, and to divide the plurality of target regions according to a classification result.

4. The robot according to claim 1, wherein the dividing module is further configured to acquire a dividing operation of a user and divide the map into the plurality of target regions according to the dividing operation of the user, wherein the dividing operation of the user is completed by performing a finger touch operation on a display interface of a mobile terminal.

5. The robot according to claim 4, wherein the dividing operation of the user comprises connecting lines to draw the target regions.

6. The robot according to claim 1, wherein the dividing module is further configured to intelligently recognize a divided map using a machine learning method.

7. The robot according to claim 1, wherein the dividing module is particularly configured to draw the plurality of target regions on the map.

8. The robot according to claim 1, wherein the dividing module is particularly configured to classify the map according to terrain features of the map and divide the plurality of target regions according to a classification result.

9. The robot according to claim 1, wherein the dividing module is particularly configured to divide the plurality of target regions according to historical tasks which are performed by the robot in different regions of the map.

10. The robot according to claim 1, wherein the marking module is configured to recognize an attribute and a corresponding confidence level of each pixel block in the map by using a trained classifier.

11. The robot according to claim 1, wherein the marking module is configured to automatically recognize an attribute of a target region according to the historical task command of the robot.

12. The robot according to claim 1, wherein the marking module is configured to acquire a marking operation of a user and mark an attribute of a target region according to the marking operation of the user.

13. The robot according to claim 1, wherein the attribute comprises a region name, a category and a mark, and the task category comprises a working mode, a working time and a working intensity.

14. The robot according to claim 1, further comprising:
a numbering module configured to number each target region in the plurality of target regions.

15. The robot according to claim 14, further comprising:
an establishment module configured to establish an association relationship between the attributes and the numbers of the plurality of target regions and multiple keys in the remote control device so as to send a corresponding control command to the robot after any one of the plurality of keys is triggered, so that the robots performs the corresponding action after entering the corresponding target region according to the corresponding attributes and the numbers.

16. A robot system, comprising:
a remote control device; and
a robot according claim 1.

17. The robot system according to claim 16, wherein the remote control device is a remote controller.

18. The robot system according to claim 16, wherein the robot system is applicable to the field of indoor floor cleaning robots.

19. The robot system according to claim 1, wherein the dividing module is particularly configured to divide the plurality of target regions drawn on the map through a software application.
